(19) United States
(12) Patent Application Publication
(10) Pub. No.: US 2005/0099367 A1
(43) Pub. Date: May 12, 2005

(54) Electron emission device and driving method thereof

(76) Inventors: Mun-Seok Kang, Suwon-si (KR); Chun-Gyoo Lee, Suwon-si (KR)

Correspondence Address: CHRISTIE, PARKER & HALE, LLP, PO BOX 7068, PASADENA, CA, 91109-7068, US

(21) Appl. No.: 10/955,939

(22) Filed: Sep. 30, 2004

(30) Foreign Application Priority Data
Oct. 1, 2003 (KR) 2003-0068361

(51) Int. Cl. G09G 3/20; G09G 3/22

(52) U.S. Cl. 345/74.1

(57) ABSTRACT

An electron emission device for controlling brightness by converting a brightness level of input video signals. The electron emission device calculates brightness levels of video data which indicate a brightness degree for each of the images corresponding to the video signals, compares the brightness levels with a reference brightness level stored in a lookup table, calculates a conversion index of the input video signals, converts the video data stored in a memory according to the calculated conversion index, and displays the images based on the converted video data.

### CROSS REFERENCE TO RELATED APPLICATION

This application claims priority to and the benefit of Korea Patent Application No. 10-2003-0068361 filed on Oct. 1, 2003 in the Korean Intellectual Property Office, the entire content of which is incorporated herein by reference.

### BACKGROUND OF THE INVENTION

(a) Field of the Invention

The present invention relates to an electron emission device. More specifically, the present invention relates to an electron emission device for varying brightness levels of input video signals to control the brightness of displayed images.

(b) Description of the Related Art

In general, a flat panel display (FPD) is a display device in which a wall is provided between two substrates to manufacture an airtight device, and appropriate elements are arranged in the airtight device to display desired images. The importance of the FPD has been emphasized following the development of multimedia technologies. In response to this trend, various flat panel displays such as the liquid crystal display (LCD), the plasma display panel (PDP), and the electron emission device (EED) have been put to practical use.

In particular, since an EED uses phosphorous emission caused by electron beams in a like manner as the cathode ray tube (CRT), it has a high probability of realizing a flat-type display which maintains excellent features of the CRT, provides no image distortion, and allows low power consumption. In particular, it satisfies viewing angle, high-rate response, high resolution, fineness, and slimness criteria, and accordingly, it has become a center of attention as the next-generation display.

Generally, there are two kinds of EED. One uses a thermionic cathode as an electron source and the other uses a cold cathode as an electron source. Also, in the EED using a cold cathode, there are the field emitter array (FEA) type, the surface conduction emitter (SCE) type, the metal-insulator-metal (MIM) or metal-insulator-semiconductor (MIS) type, and the ballistic electron surface emitting (BSE) type.

A typical EED is composed of a triode structure having cathode, anode and gate electrodes. More specifically, the cathode electrode that is generally used as a data electrode is formed on a substrate. An insulation layer has a contact hole, and the gate electrode generally used as a scan electrode is integrated on the insulation layer. Additionally, an emitter used as an electron source is formed inside the contact hole and is connected to the cathode electrode. Alternatively, the gate electrode can be a data electrode and the cathode electrode can be a scan electrode. That is, the cathode electrode can be used as either a scan electrode or a data electrode, and the gate electrode can be used as the other, according to the structure of the EED.

The above-configured electron emission display concentrates high fields on the acute cathode, that is, the emitter, to emit the electrons according to the quantum-mechanical tunnel effect, and the electrons emitted from the emitter are accelerated by the voltage applied between the cathode electrode and the anode electrode and are collided with the red, green and blue (RGB) phosphor layers formed on the anode electrode, thereby emitting the light and displaying images.

Brightness of the images displayed when the emitted electrons are collided with the phosphor surface to allow the phosphor to emit light is varied according to values of input digital video signals. In detail, the values of the digital video signals have 8-bit RGB data. That is, since the values of the digital video signals cover 0 (00000000₍₂₎) to 255 (11111111₍₂₎), 256 gray scales are represented by the 256 values, and the brightness of colors are represented by the digital values.

In order to control the brightness which is represented according to the digital video signals, a pulse width modulation (PWM) method or a pulse amplitude modulation (PAM) method is generally used.

The PWM method is a method for modulating the pulse width of a driving waveform applied to the data electrode according to the digital video signals input by a data electrode driver, and the PAM method is a method for modulating the amplitude of a driving waveform applied to the data electrode by the data electrode driver. The above-modulated driving waveforms are applied to the EED panel to display the video.

In more detail, the PWM method represents the method for modulating the pulse width of the driving waveform applied to the data electrode according to the respective 8-bit RGB data. When the value of 255 is input as a value of the digital video signal within the available maximum On-time, the pulse width is maximized and the maximum brightness is displayed, and when the value of 127 is input as a value of the digital video signal, the pulse width becomes ½ of the maximum brightness, and the brightness is reduced. The PAM method allows a substantially constant pulse width irrespective of the input digital video signals, and controls the brightness by differentiating the pulse voltage level (i.e., the magnitude of the pulse) of the driving waveform applied to the data electrode according to the input digital video signals.

When the digital video signal with R:11111111₍₂₎, G11111111₍₂₎, and B:11111111₍₂₎, that is, the digital video signal with the value of 255 is input to the data electrode driver in the above-referenced EED, the pulse width or the amplitude is modulated and the brightness is determined according to the digital video signals and irrespective of the case when the total screen is a full white mode or when a part of the screen is a window white mode, that is, irrespective of the total brightness level of the digital video signals. Accordingly, no difference is generated between the brightness of the screen in the full white mode and the brightness of the screen in the window white mode.

Hence, it is difficult to expect a white visual characteristic in moving pictures. Also, in the case of the full white mode, the amount of the current flowing to the emitter of the cathode is increased to generate arcing, and the increased current provides a bad influence to the lifetime of the EED.

### SUMMARY OF THE INVENTION

In exemplary embodiments according to the present invention, is provided an electron emission device panel driver for converting digital video signals according to the brightness level of the input digital video signals to control the brightness.

In an exemplary embodiment of the present invention, an electron emission device including a driver operable to display images corresponding to input video signals on a display panel, is provided. The electron emission device includes an operator for calculating brightness levels of video data which indicate a brightness degree for each of the images corresponding to the video signals. The electron emission device also includes a storage unit for storing the video data for each of the images corresponding to the video signals, a comparator for calculating conversion indices of the video signals based on the brightness levels calculated by the operator, and a data converter for converting the video data stored in the storage unit using the conversion indices to generate converted video data, and applying the converted video data to the driver.

At least one of the images may be a one frame image, and the storage unit may be a frame memory.

At least one of the images may be a one line image, and the storage unit may be a line memory.

The operator may include an adder for adding the video data for each of the images to generate a video data sum, and a divider for calculating a mean value of the video data sum generated by the adder.

The comparator may further include a lookup table for storing reference brightness levels of the video signals and data conversion indices according to the reference brightness levels.

In another exemplary embodiment of the present invention, a method for driving an electron emission device operable to display images corresponding to input video signals on a display panel, is provided. The method includes: (a) storing video data for each of the images corresponding to the video signals; (b) calculating brightness levels of the video data which indicate a brightness degree for each of the images corresponding to the video signals; and (c) calculating a conversion index of the video signals based on the calculated brightness levels. The method also includes: (d) converting the video data stored in (a) using the conversion index; and (e) displaying the images according to the converted video data.

At least one of the images may be a one frame image or a one line image.

The step (b) may include adding video data for each of the images to generate a video data sum, and calculating a mean value of the video data sum.

The step (a) may be continuously performed while (b) and (c) are performed.

In yet another exemplary embodiment according to the present invention, an electron emission device including a driver operable to display images corresponding to input first and second video signals on a display panel, is provided. The electron emission device includes a calculator for calculating a size of a first white image corresponding to the first video signal and a size of a second white image corresponding to the second video signal, and a data converter for converting video data of the first and second video signals so that the first white image and the second white image can be white images with different brightness levels based on the sizes of the first and second white images calculated by the calculator.

### BRIEF DESCRIPTION OF THE DRAWINGS

The accompanying drawings, together with the specification, illustrate exemplary embodiments of the present invention, and, together with the description, serve to explain the principles of the present invention:

FIG. 1 shows a full white mode and a window white mode with a part of the screen in white;

FIG. 2 shows a simplified view of an EED according to a first exemplary embodiment of the present invention;

FIG. 3 shows a timing diagram to which data calculation and data conversion per frame are applied in the EED of FIG. 2;

FIG. 4 shows a simplified view of an EED according to a second exemplary embodiment of the present invention; and

FIG. 5 shows a timing diagram to which data calculation and data conversion per line are applied in the EED of FIG. 4.

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive. To clarify the present invention, parts which are not described in the specification may have been omitted.

FIG. 1 shows a full white mode 100 wherein an overall brightness level is high, and a window white mode 110 wherein a part of the screen is white. It can be seen in FIG. 1 that a white area 120 of the screen is surrounded by darker areas.

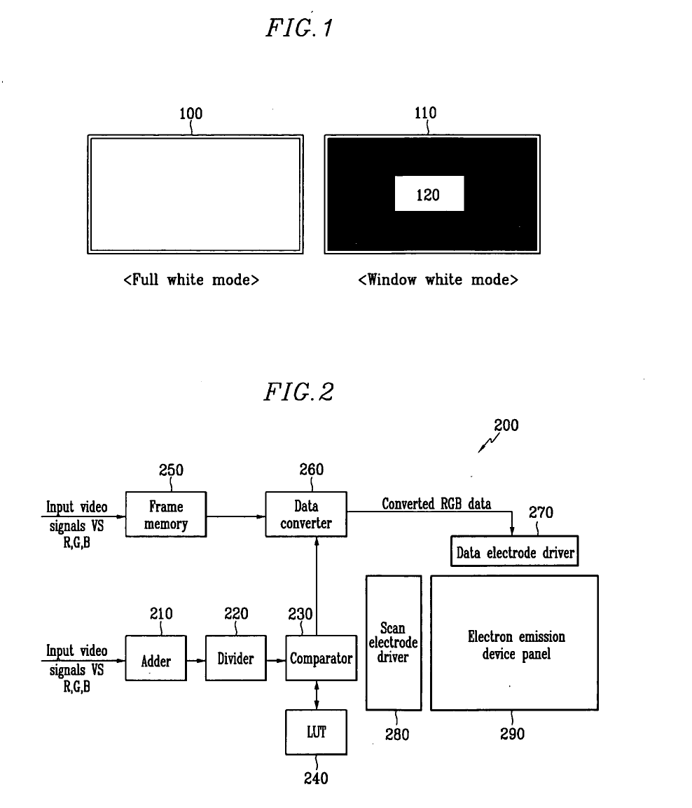

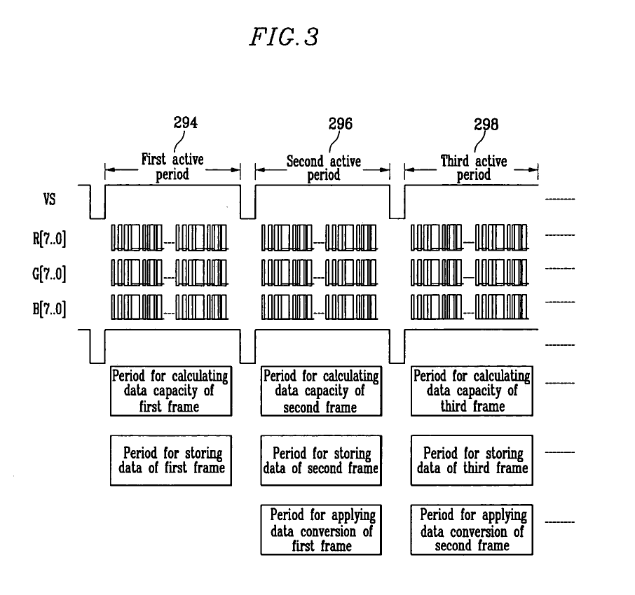

FIG. 2 shows a simplified view of an EED 200 according to a first exemplary embodiment of the present invention.

The EED 200 converts data for each frame according to the brightness level of the video signals, and controls the brightness.

The EED 200 includes an adder 210 for adding the input video signals for each frame; a divider 220 for finding a mean value of the frame-based brightness levels; a lookup table (LUT) 240 for storing reference data which indicate the brightness degree of the video (i.e., images corresponding to the video signals) according to the mean value, a comparator 230 for comparing the mean value calculated by the divider 220 with the reference data of the LUT 240; a frame memory 250 for storing the input video signals for each frame; a data converter 260 for converting the brightness levels of the input video signals according to the compared result; a data electrode driver 270; a scan electrode driver 280; and an EED panel 290.

Video signals together with a vertical synchronization signal (VS) are input to the adder 210. In order to calculate the brightness level of the video signals for each frame, the adder 210 adds respective 8-bit RGB data in an active period of one frame, that is, one VS signal period. Added results are output to the divider 220 for calculating the mean value of one frame.

The divider 220 calculates the mean value of the respective 8-bit RGB data, and the brightness of the video signals to be displayed is known from the mean value. That is, the case in which the brightness level of the mean value calculated by the divider 220 is high indicates that the screen looks bright as a whole, and the case in which the brightness level of the mean value calculated by the divider 220 is low indicates that the screen looks relatively dark.

The LUT 240 stores mean values of reference brightness levels of the video signal data, and data conversion indices on respective detailed stages of from brightness to darkness according to the mean values. Alternatively, the mean values and the data conversion indices may be generated by the comparator 230 using logic circuits without separately providing the LUT 240.

The comparator 230 compares the mean value calculated for a specific frame by the divider 220 with the mean value of the reference brightness level stored in the LUT 240. The comparator 230 determines the data conversion index of the video signals according to a higher or lower value of the brightness levels of the specific frame, and outputs the data conversion index to the data converter 260.

The frame memory 250 stores one frame data in order to apply conversion of the video signals of the corresponding frame while the total of one-frame video signals are calculated and the same are compared with the reference brightness levels of the LUT 240.

The data converter 260 converts the one-frame video signal data stored in the frame memory 250 and the corresponding frame into predetermined brightness level signals based on the data conversion index of the video signals determined by the comparator 230.

For example, when the mean value of the overall screen is high as given by 255 (11111111₍₂₎) in a like manner as the full white mode, and the data conversion index is 70%, the data converter 260 performs a data modification process to lower the brightness level of 255 to 70% (255×0.7=178) in order to reduce the brightness of the corresponding frame.

Also, when the mean value of the whole screen is lower than the value of 100, the data conversion index becomes 100%, for example, and the data converter 260 outputs the original video signals to the data electrode driver 270 and the scan electrode driver 280 without data-modulating the original video signals.

FIG. 3 shows a timing diagram to which data calculation and data conversion per frame are applied in the EED 200 of FIG. 2.

As shown, the respective 8-bit RGB data corresponding to the first frame are input during a first active period 294 of the VS signal for distinguishing frames. During the first active period 294, the video data corresponding to the first frame are added by the adder 210, their mean values are calculated by the divider 220, and the mean values are compared with the reference brightness levels of the LUT 240 by the comparator 230 to determine a data conversion index. This way, a data capacity of the first frame is calculated. The calculation process of the first frame is finished when the total frame signals are input. The video signal data of the first frame are input and stored in the frame memory 250 while the one-frame data are calculated.

In a second active period 296 of the VS signal, the video data corresponding to the second frame are added by the adder 210, their mean values are calculated by the divider 220, and the mean values are compared with the reference brightness levels of the LUT 240 by the comparator 230 to determine a data conversion index. This way, a data capacity of the second frame is calculated. The calculation process of the second frame is finished when the total frame signals are input. The video signal data of the second frame are input and stored in the frame memory 250 while the second-frame data are calculated. Also, in the second active period 296 of the VS signal, the video signal data of the first frame stored in the frame memory 250 during the first active period 294 and the data conversion index of the first frame are output to the data converter 260, and the data converter 260 performs data conversion on the video signals of the first frame.

In a third active period 298, in a similar manner as in the first active period 294 and the second active period 296, a data capacity of a third frame is calculated, and the third frame is stored in the frame memory 250. Further, the data converter 260 performs data conversion on the video signals of the second frame.

Therefore, the data calculation results of the frames are applied to the conversion on the data of the corresponding frames by controlling the inputs and outputs of the frame memory 250 according to the VS signal.

The data conversion index is classified or combined according to the characteristic of the EED panel, the input data, and the varied degree of the generated brightness. The original video signals are converted with the corresponding digital data according to the data conversion indices, for example, of 80, 85, 90, 95, and 100%. Hence, the white with high brightness is realized when the brightness for each frame is low, and the white with relatively low brightness is realized when the brightness for each frame is high.

Hence, according to the first exemplary embodiment, the input digital video data are calculated for each frame, the brightness level is reduced to a substantially constant reference in the case of the full white mode (or a bright screen which corresponds to the full white mode) according to the calculation result to thus realize a stable screen, and an overcurrent flow to the cathode is reduced or prevented. Also, the brightness is relatively improved by applying the input data values to the display panel or increasing the same and then applying the increased data values to the display panel when the data having a capacity less than the full white mode are input such as the window white mode.

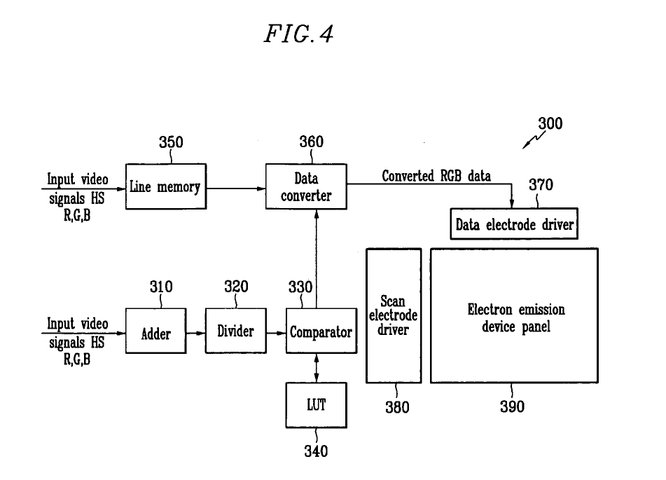

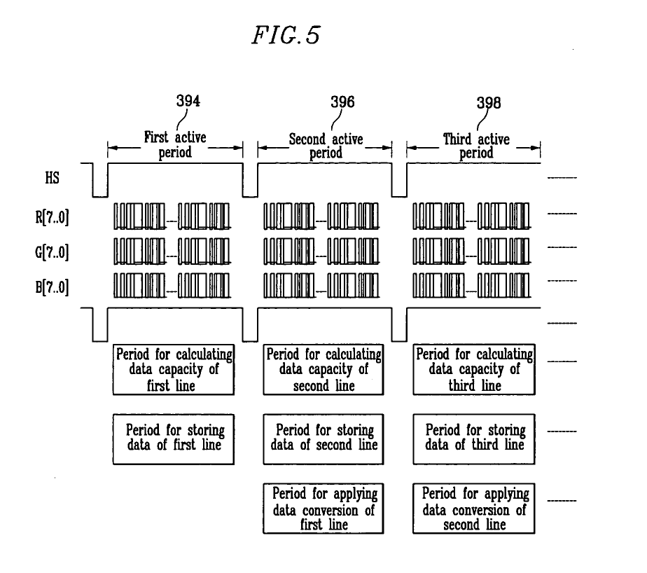

FIG. 4 shows a simplified view of an EED 300 according to a second exemplary embodiment of the present invention.

The EED 300 shown in FIG. 4 converts data for each line according to the brightness level of the video signals to thus control the brightness. The EED 300 according to the second exemplary embodiment uses a line memory 350 to calculate the brightness level of the video signals for each line, which is different from the EED 200 according to the first exemplary embodiment, where a frame memory is used to store each frame for brightness level calculations.

The EED 300 includes an adder 310 for adding the input video signals for each line; a divider 320 for finding a mean value of the line-based brightness levels; an LUT 340 for storing reference brightness levels which indicate the brightness degree of the video according to the mean value, and data conversion indices; a comparator 330 for comparing the mean value calculated by the divider 320 with the reference brightness levels of the LUT 340, and determining a data conversion index; a line memory 350 for storing the input video signals for each line; a data converter 360 for converting the brightness levels of the input video signals according to the compared result; a data electrode driver 370; a scan electrode driver 380; and an EED panel 390.

Video signals together with a horizontal synchronization signal (HS) are input to the adder 310. In order to calculate the mean value of the brightness level of the video signal for each line, the adder 310 adds respective 8-bit RGB data in an active period of one line, that is, one HS signal. Added results are output to the divider 320 for calculating the mean value of one line.

The divider 320 calculates the mean value of the respective 8-bit RGB data, and the brightness of the video signals to be displayed is known from the mean value. That is, the case in which the brightness level of the mean value calculated by the divider 320 is high indicates that the screen looks bright as a whole, and the case in which the brightness level of the mean value calculated by the divider 320 is low indicates that the screen looks relatively dark.

The LUT 340 stores mean values of reference brightness levels of the video signal data, and data conversion indices on respective detailed stages of from brightness to darkness according to the mean values. Alternatively, the mean values and the data conversion indices may be generated by the comparator 330 using logic circuits without separately providing the LUT 340.

The comparator 330 compares the mean value calculated for a specific line by the divider 320 with the reference brightness level stored in the LUT 340. Accordingly, the comparator 340 determines the data conversion index of the video signals according to a higher or lower value of the brightness levels of the specific line, and outputs the data conversion index to the data converter 360.

The line memory 350 stores one line data in order to apply conversion of the video signals of the corresponding line while the total of one-line video signals are calculated and the same are compared with the reference brightness levels of the LUT 340.

The data converter 360 converts the one-line video signal data stored in the line memory 350 and the corresponding line into a predetermined brightness level signals based on the data conversion index of the video signals determined by the comparator 330.

FIG. 5 shows a timing diagram to which data calculation and data conversion per line are applied in the EED 300 of FIG. 4.

As shown, the respective 8-bit RGB data corresponding to the first line are input during a first active period 394 of the HS signal for distinguishing lines. During the first active period 394, the video data corresponding to the first line are added by the adder 310, their mean values are calculated by the divider 320, and the mean values are compared with the reference brightness levels of the LUT 340 by the comparator 330 to determine a data conversion index. This way, a data capacity of the first line is calculated. The calculation process of the first line is finished when the total line signals are input. The video signal data of the first line are input and stored in the line memory 350 while the one-line data are calculated.

In a second active period 396 of the HS signal, the video data corresponding to the second line are added by the adder 310, their mean values are calculated by the divider 320, and the mean values are compared with the reference data of the LUT 340 by the comparator 330 to determine a data conversion index. This way, a data capacity of the second line is calculated. The calculation process of the second line is finished when the total line signals are input. The video signal data of the second line are input and stored in the line memory 350 while the second-line data are calculated. Also, in the second active period of the HS signal, the video signal data of the first line stored in the line memory 350 during the first active period and the data conversion index of the first line are output to the data converter 360, and the data converter 360 performs data conversion on the video signals of the first line.

In a third active period 398, in a similar manner as in the first active period 394 and the second active period 396, a data capacity of a third line is calculated, and the third line is stored in the line memory 350. Further, the data converter 360 performs data conversion on the video signals of the second line.

Therefore, the data calculation results of the lines are applied to the conversion on the data of the corresponding lines by controlling the inputs and outputs of the line memory 350 according to the HS signal, thereby obtaining the same effect as that of the first exemplary embodiment.

According to the exemplary embodiments of the present invention, the brightness is controlled by converting the video data according to the brightness level of the input digital video signals. That is, for example, the video data are converted so that the brightness levels may be reduced as a whole when the overall brightness level for each frame is high in a like manner as the full white mode or similar screens, and the video data remain as they are or are converted to be higher when the brightness level is low in a like manner as the window white mode, thereby controlling the brightness of the displayed video.

Further, the arcing is prevented or reduced since no amount of the current flowing to the emitter of the cathode is increased when the brightness level is high in a like manner as the full white mode, thereby extending the lifetime of the EED.

While this invention has been described in connection with certain exemplary embodiments, it is to be understood that the present invention is not limited to the disclosed embodiments, but, on the contrary, is intended to cover various modifications and equivalent arrangements included within the spirit and scope of the appended claims.

1. An electron emission device including a driver operable to display images corresponding to input video signals on a display panel, comprising:
an operator for calculating brightness levels of video data which indicate a brightness degree for each of the images corresponding to the video signals;
a storage unit for storing the video data for each of the images corresponding to the video signals;
a comparator for calculating conversion indices of the video signals based on the brightness levels calculated by the operator; and
a data converter for converting the video data stored in the storage unit using the conversion indices to generate converted video data, and applying the converted video data to the driver.

2. The electron emission device of claim 1, wherein at least one of the images is a one frame image.

3. The electron emission device of claim 2, wherein the storage unit is a frame memory.

4. The electron emission device of claim 1, wherein at least one of the images is a one line image.

5. The electron emission device of claim 4, wherein the storage unit is a line memory.

6. The electron emission device of claim 2, wherein the operator comprises:
an adder for adding the video data for each of the images to generate a video data sum; and
a divider for calculating a mean value of the video data sum generated by the adder.

7. The electron emission device of claim 1, wherein the comparator further comprises a lookup table for storing reference brightness levels of the video signals and data conversion indices according to the reference brightness levels.

8. The electron emission device of claim 1, wherein the data converter converts the video data so that a first white image of a first size corresponding to a first one of the video signals and a second white image of a second size corresponding to a second one of the video signals can have different brightness levels.

9. The electron emission device of claim 8, wherein the first size is greater than the second size, and a brightness level of the first white image is lower than a brightness level of the second white image.

10. The electron emission device of claim 9, wherein the first white image is a full white mode, and the second white image is a window white mode.

11. A method for driving an electron emission device operable to display images corresponding to input video signals on a display panel, comprising:
(a) storing video data for each of the images corresponding to the video signals;
(b) calculating brightness levels of the video data which indicate a brightness degree for each of the images corresponding to the video signals;
(c) calculating a conversion index of the video signals based on the calculated brightness levels;
(d) converting the video data stored in (a) using the conversion index; and
(e) displaying the images according to the converted video data.

12. The method of claim 11, wherein at least one of the images is a one frame image.

13. The method of claim 11, wherein at least one of the images is a one line image.

14. The method of claim 11, wherein (b) comprises:
adding video data for each of the images to generate a video data sum; and
calculating a mean value of the video data sum.

15. The method of claim 11, wherein (a) is continuously performed while (b) and (c) are performed.

16. The method of claim 14, wherein (a) is continuously performed while (b) and (c) are performed.

17. An electron emission device including a driver operable to display images corresponding to input first and second video signals on a display panel, comprising:
a calculator for calculating a size of a first white image corresponding to the first video signal and a size of a second white image corresponding to the second video signal; and
a data converter for converting video data of the first and second video signals so that the first white image and the second white image can be white images with different brightness levels based on the sizes of the first and second white images calculated by the calculator.

18. The electron emission device of claim 17, wherein the calculator comprises:
an operator for calculating brightness levels of video data which indicate a brightness degree of the first and second video signals, and for determining sizes of the first and second white images; and
a comparator for determining conversion indices of the first and second video signals based on the sizes of the first and second white images calculated by the operator,
wherein the data converter converts the video data of the video signals using the conversion indices to generate converted video data, and applies the converted video data to the driver.

19. The electron emission device of claim 18, wherein the size of the first white image is greater than the size of the second white image, and the brightness level of the first white image is lower than the brightness level of the second white image.

20. The electron emission device of claim 19, wherein the first white image is a full white mode, and the second white image is a window white mode.
